(19) United States
(12) Patent Application Publication
(10) Pub. No.: US 2021/0195507 A1
(43) Pub. Date: Jun. 24, 2021

(54) Traffic Steering Between LTE and NR

(71) Applicant: Telefonaktiebolaget LM Ericsson (publ), Stockholm (SE)

(72) Inventors: Jinyin Zhu, Shanghai (CN); Ralf Keller, Würselen (DE)

(21) Appl. No.: 16/767,794

(22) PCT Filed: Dec. 21, 2017
(86) PCT No.: PCT/CN2017/117639

§ 371 Date: May 28, 2020

(51) Int. Cl. H04W 48/16; H04W 8/08; H04W 8/04; H04M 15/00; H04W 76/15

(52) U.S. Cl. CPC H04W 48/16; H04W 8/08; H04W 76/15; H04M 15/66; H04W 8/04

(57) ABSTRACT

System comprising a mobility management entity, MME (103), a first Radio Access node, RAN (102, eNB) offering Long Term Evolution, LTE, access, and a second radio access node, RAN (108, gNB) offering New Radio, NR, access; a user entity, UE (101), supporting both Long Term Evolution, LTE, and New Radio, NR, Radio Access Technology, RAT. The MME (103) is resolving (74) a Radio Access Technology restriction information, RAT RI, from the at least two instances of RAT RI pertaining to restrictions for a UE as to support dual connectivity over LTE access and NR access respectively for a Packet Data Network, PDN, connectivity session. The first RAN (102) is receiving (75) the resolved RAT RI and is enforcing (77) bearer setup in accordance with the resolved RAT RI.

### TECHNICAL FIELD

The present invention is directed to methods and apparatuses involving Packet Data Network, PDN, level traffic steering between Long Term Evolution, LTE, and New Radio, NR, radio access technologies.

### BACKGROUND

The well-known SAE-LTE (System Architecture Evolution-Long Term Evolution) architecture has been shown in FIG. 1. In the 5G work in 3GPP a split between Mobility Management (MM) and Session Management (SM) has been defined compared to in EPC, (Evolved Packet Core) where MME (Mobility management Entity) supports both MM (Mobility management) and some SM (Session management) functionality. The Access and Mobility Function (AMF) supports MM functionality and the Session Management Function (SMF) supports SM functionality. The AMF (Application Mobility Function) selects the SMF. Different SMFs may be selected for different PDU (Packet Data Unit) Sessions of a UE (User Entity), e.g. PDU Sessions to different Data Network Names (DNNs)/Access Point Name, APNs, or the same SMF may be used. The reference architecture is shown in the FIG. 2, which corresponds to TS 23.501 V0.5.0 (2017 May), FIG. 4.2.3-3.

In FIG. 3 corresponding to 3GPP TS 38.300 V1.2.1 (2017 November), FIGS. 4.1-1, the Overall Architecture and Functional Split is shown. An NG-RAN (Next Generation/New radio-Radio Access Node) node is either:
a gNodeB, QNB, providing NR (New Radio/5G) user plane and control plane protocol terminations towards the UE; or
a next generation eNodeB, ng-eNB, providing E-UTRA (Evolved Universal Mobile Telecommunications System (UMTS) Terrestrial Radio Access) user plane and control plane protocol terminations towards the UE.

The gNBs and ng-eNBs are interconnected with each other by means of the Xn interface. The gNBs and ng-eNBs are also connected by means of the NG interfaces to the SGC, more specifically to the AMF (Access and Mobility Management Function) by means of the NG-C interface and to the UPF (User Plane Function) by means of the NG-U interface (see 3GPP TS 23.501).

In 5G scenarios in 3GPP NR & Next Generation Core (NG Core) so-called options 3, 3a, 3x, c.f. FIG. 4, are known as deployment options for 5G where NR can serve as the secondary RAT (Radio Access Technology) to LTE. For the S1 control plane interface, it is the same for all these options and it is always anchored in LTE eNodeB. For S1 user plane interface, it is specific per option: for option 3, it is always anchored in LTE eNodeB; for option 3a, it can be anchored on both LTE eNodeB (corresponding to ng-eNB) and NR GNodeB (gNB); for option 3x, it is always anchored on NR GNodeB (gNB).

FIG. 5 and FIG. 6 show known control plane and user plane interfaces.

For the radio interface, the UE can connect to both eNodeB (LTE) and GNodeB (NR) simultaneously if UE supports dual radio. In each particular option, for each EPS bearer, it is the eNodeB that decides the traffic steering between the LTE and the NR radio interface.

However, these options may give rise to certain technical complications.

### SUMMARY

For the options 3, 3a, 3x, shown in FIG. 4, the eNodeB decides, or enforces, the traffic steering between the LTE and the NR radio for each EPS bearer. However, for the IMS service VoLTE (Voice Over LTE) and ViLTE (Video Over LTE) there might be problems for some UEs, e.g. the UEs which have two processors (one for LTE and one for NR) to have the traffic from voice and video bearers to be transferred on different radio access technologies, RAT's. Meanwhile, from a network perspective, depending on the local policy (in HPLMN (Home Public Land Mobile Network) and VPLMN (Visitor Public Land Mobile Network) respectively in case of roaming) and depending on the roaming agreement, there might be different RAT usage policies for service to different APN's, e.g. the IP Multimedia Subsystem, IMS, service may not be allowed on NR while internet service is allowed. The inventors of the present application have reckoned that for deciding to apply the appropriate traffic steering between LTE and NR for a UE in question, the eNodeB does not have sufficient information. The same problem may exist also for other dualconnectivity deployments specified in the art, i.e., for Option 4 and Option 7.

It is a first object to set forth a methods and apparatuses for providing improved and more reliable services for such dual connectivity UE's.

This object has been solved by at least one of the following methods:

A method for a system comprising a mobility management entity, MME, a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN.

The MME is
receiving or looking-up internally instances of Radio Access Technology restriction information, RAT RI, from at least two of the HSS, the PCRF and the MME; the instances of RAT RI pertaining to restrictions for a UE as to support dual connectivity over LTE access and NR access respectively for a Packet Data Network, PDN, connectivity session;
resolving a RAT RI from the at least two instances of RAT RI;
transmitting the resolved RAT RI at least to the first RAN;
   and the first RAN is
receiving the resolved RAT RI;
enforcing bearer setup in accordance with the resolved RAT RI.

A method for a mobility management entity, MME, in a system comprising a first Radio Access node, RAN offering Long Term Evolution, LTE, access, and a second radio access node, RAN offering New Radio, NR, access;
a user entity, UE, supporting both Long Term Evolution, LTE, and New Radio, NR, Radio Access Technology, RAT,
   the MME moreover being adapted for signalling with a Home Subscription Server, HSS, a Serving Packet Data Network Gateway, a PDN Gateway, and a Policy and Charging Rules Function, PCRF;
   the system providing control plane functionality via the first RAN and user plane functionality via either the first RAN or the second RAN; and wherein

### the MME

receiving or looking-up instances of Radio Access Technology restriction information, RAT RI, pertaining to restrictions for a UE as to support dual connectivity over LTE and NR for a PDN connectivity session, from at least two of
   the HSS, the PCRF and internally in the MME;
resolving a RAT RI from the at least two instances of RAT RI's;
transmitting the resolved RAT RI at least to the RAN.

A method for a first Radio Access node, RAN offering Long Term Evolution, LTE, access in a system comprising a mobility management entity, MME, and a second radio access node, RAN offering New Radio, NR, access;

a user entity, UE, supporting both Long Term Evolution, LTE, and New Radio, NR, Radio Access Technology, RAT;
the MME moreover being adapted for signalling with a Home Subscription Server, HSS, a Serving Packet Data Network Gateway, a PDN Gateway, and a Policy and Charging Rules Function, PCRF.

The system is providing control plane functionality via the first RAN and user plane functionality via either the first RAN or the second RAN;

the MME is moreover being adapted for signalling with a Home Subscription Server, HSS, a Serving Packet Data Network Gateway, a PDN Gateway, and a Policy and Charging Rules Function, PCRF;

### the RAN;

receiving a resolved RAT RI;
enforcing bearer setup in accordance with the resolved RAT RI.

A method for a Home Subscriber Sever, HSS, in in a system comprising a mobility management entity, MME, a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN;
the method comprising the HSS
upon receiving an Update Location Request message from the MME;
providing an Update Location Response message comprising a RAT RI, having a value indicative of at least the UE's ability to handle RAT's to the MME.

A method for a gateway entity comprising a SGW and/or PGW, in in a system comprising a mobility management entity, MME, a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF.

The system is providing control plane functionality via the first RAN and user plane functionality via either the first RAN or the second RAN;

the gateway entity is
receiving from the MME a Create Session Request;
transmitting a CCR-I message to the PCRF;
receiving from the PCRF a CCA-I message comprising an instance of RAT RI;
transmitting a create session response message including the received instance of the instance of the RAT RI to the MME.

A method for a user entity, UE, in a system comprising a mobility management entity, MME, a first Radio Access node, RAN offering Long Term Evolution, LTE, ac-cess, and a second radio access node, RAN offering New Radio, NR, access;

the user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN.

The user entity is being adapted for
transmitting a PDN connectivity request from a dual connectivity UE comprising an instance of a RAT RI,
receiving from the MME an activate default EPS bearer context request.

The object mentioned above has moreover been solved by at least one of:

A system comprising a mobility management entity, MME, a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN;
the MME being adapted for
receiving or looking-up internally instances of Radio Access Technology restriction information, RAT RI, from at least two of the HSS, the PCRF and the MME; the instances of RAT RI pertaining to restrictions for a UE as to support dual connectivity over LTE access and NR access respectively for a Packet Data Network, PDN, connectivity session;
resolving a RAT RI from the at least two instances of RAT RI;
transmitting the resolved RAT RI at least to the first RAN;
   the first RAN
receiving the resolved RAT RI;
enforcing bearer setup in accordance with the resolved RAT RI.

A mobility management entity, MME, in a system comprising a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN;
the MME comprising processing circuitry being operative to
receiving or looking-up instances of Radio Access Technology restriction information, RAT RI, pertaining to restrictions for a UE as to support dual connectivity over LTE and NR for a PDN connectivity session, from at least two of
   the HSS, the PCRF and internally in the MME;
resolving a RAT RI from the at least two instances of RAT RI's;
transmitting the resolved RAT RI at least to the RAN.

A Radio Access node, RAN offering Long Term Evolution, LTE, access in a system comprising a mobility management entity, MME, and a second radio access node, RAN offering New Radio, NR, access;

a user entity, UE, supporting both Long Term Evolution, LTE, and New Radio, NR, Radio Access Technology, RAT;
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN;
the MME moreover being adapted for signalling with a Home Subscription Server, HSS, a Serving Packet Data Network Gateway, a PDN Gateway, and a Policy and Charging Rules Function, PCRF;
RAN comprising processing circuitry being operative to:
receiving a resolved RAT RI;
enforcing bearer setup in accordance with the resolved RAT RI.

A User entity, UE, in a system comprising a mobility management entity, MME, a first Radio Access node, RAN offering Long Term Evolution, LTE, access, and a second radio access node, RAN offering New Radio, NR, access;
the user entity, UE, supporting both Long Term Evolution, LTE, and New Radio, NR, Radio Access Technology, RAT,
   the MME moreover being adapted for signalling with a Home Subscription Server, HSS, a Serving Packet Data Network Gateway, a PDN Gateway, and a Policy and Charging Rules Function, PCRF;
   the system providing control plane functionality via the first RAN and user plane functionality via either the first RAN or the second RAN;
   the user entity comprising processing circuitry being adapted for
transmitting a PDN connectivity request from a dual connectivity UE comprising an instance of a RAT RI,
receiving from the MME an activate default EPS bearer context request.

A gateway entity comprising a SGW and/or PGW, in in a system comprising a mobility management entity, MME, a first Radio Access node, RAN offering Long Term Evolution, LTE, access, and a second radio access node, RAN offering New Radio, NR, access;

a user entity, UE, supporting both Long Term Evolution, LTE, and New Radio, NR, Radio Access Technology, RAT,
the MME moreover being adapted for signalling with a Home Subscription Server, HSS, a Serving Packet Data Network Gateway, a PDN Gateway, and a Policy and Charging Rules Function, PCRF;
the system providing control plane functionality via the first RAN and user plane functionality via either the first RAN or the second RAN;
the gateway entity comprising processing circuitry being adapted for
receiving from the MME a Create Session Request;
transmitting a CCR-I message to the PCRF;
receiving from the PCRF a CCA-I message comprising an instance of RAT RI;
transmitting a create session response message including the received instance of the instance of the RAT RI to the MME.

According to an embodiment of the invention IMS services, such as VoLTE and ViLTE services, can be provided reliably. The services may moreover be dependent on a UE's service capability and network policies.

According to one aspect during PDN connection setup procedure, if configured in the UE, the UE additionally includes RAT restriction information in the PDN Connectivity Setup Request message.

Also during a PDN connection setup procedure, the network decides the RAT restriction for this PDN. The decision can be based on subscription data, roaming agreement, local policy, etc.

MME gathers all the information from UE and network and makes the final decision of RAT restriction for this PDN. Then MME transfers the RAT restriction information to eNodeB for each EPS bearer belonging to the PDN.

According to one aspect of the invention during a PDN connection setup procedure, if configured in UE, the UE additionally includes RAT restriction information in the PDN Connectivity Setup Request message.

### BRIEF DESCRIPTION OF THE DRAWINGS

FIG. 1 shows a known reference architecture for a LTE access and core network system for a non-roaming scenario,

FIG. 2 shows a known reference architecture for a 5G access and core network system for a non-roaming scenario,

FIG. 3 shows a known reference architecture for a LTE and 5G access and 5G core network system,

FIG. 4 shows known various options for a user entity having access to the FIG. 3 system,

FIG. 5, 6 show known control plane and user plane interfaces,

FIG. 7 shows an embodiment of the invention,

FIG. 8 shows additional flow diagrams of embodiments of the invention,

FIGS. 9-13 show further embodiments of the invention,

FIG. 14 shows examples of how user plane bearers according to embodiments of the invention are enforced,

FIG. 15 show various nodes for implementing aspects of the invention,

FIG. 16 shows an implementation of aspects of the invention in a virtualized environment,

FIG. 17 schematically illustrates a telecommunication network connected via an intermediate network to a host computer,

FIG. 18 is a generalized block diagram of a host computer communicating via a base station with a user equipment over a partially wireless connection,

FIGS. 19 and 20 are flowcharts illustrating methods implemented in a communication system including a host computer, a base station and a user equipment.

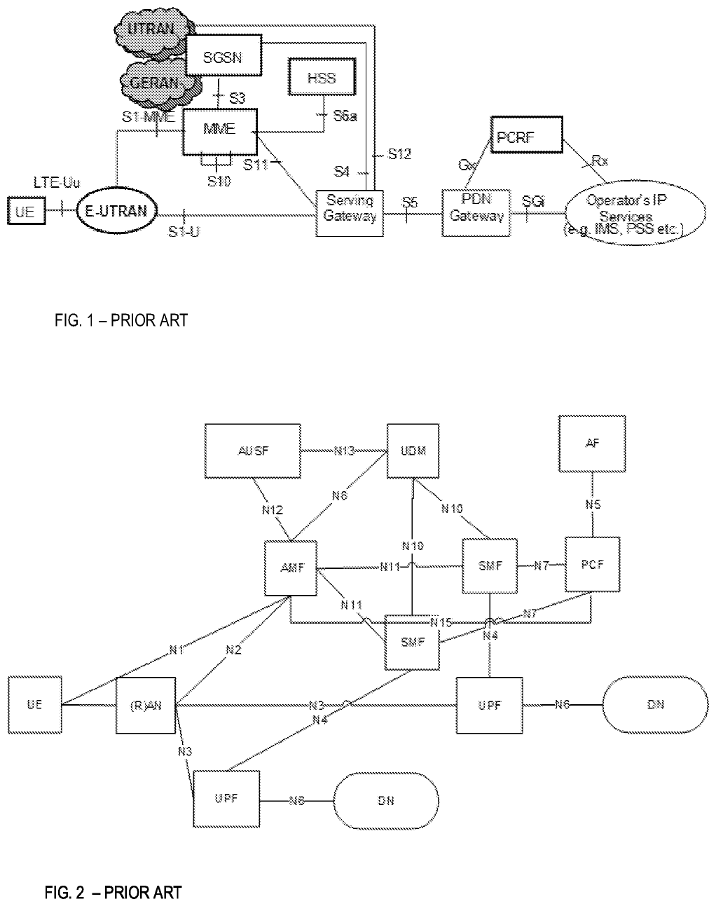

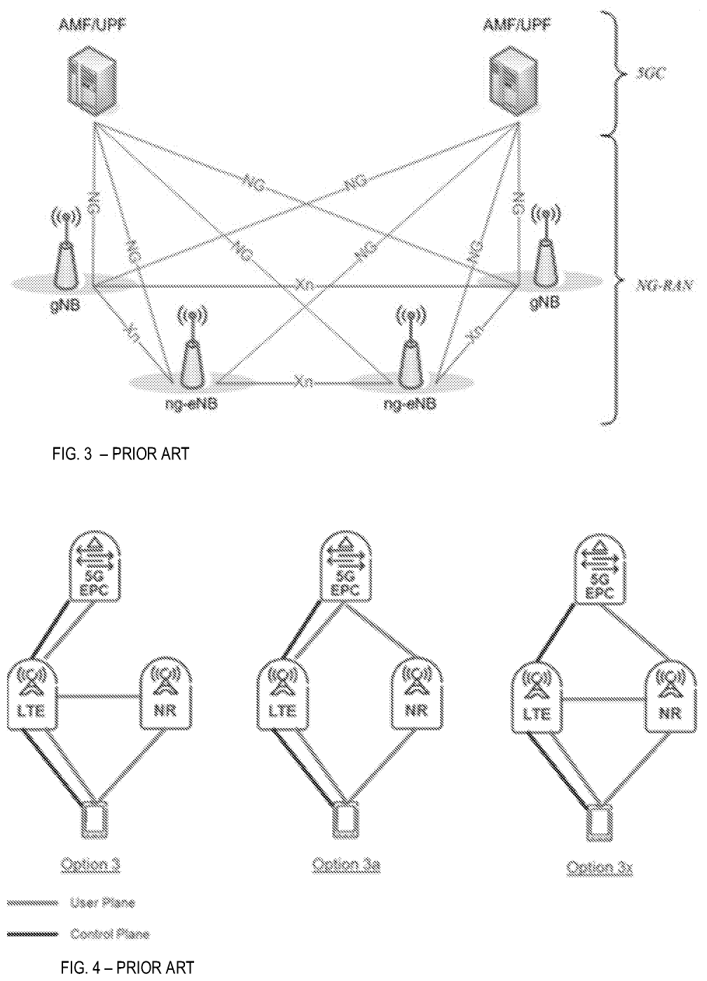

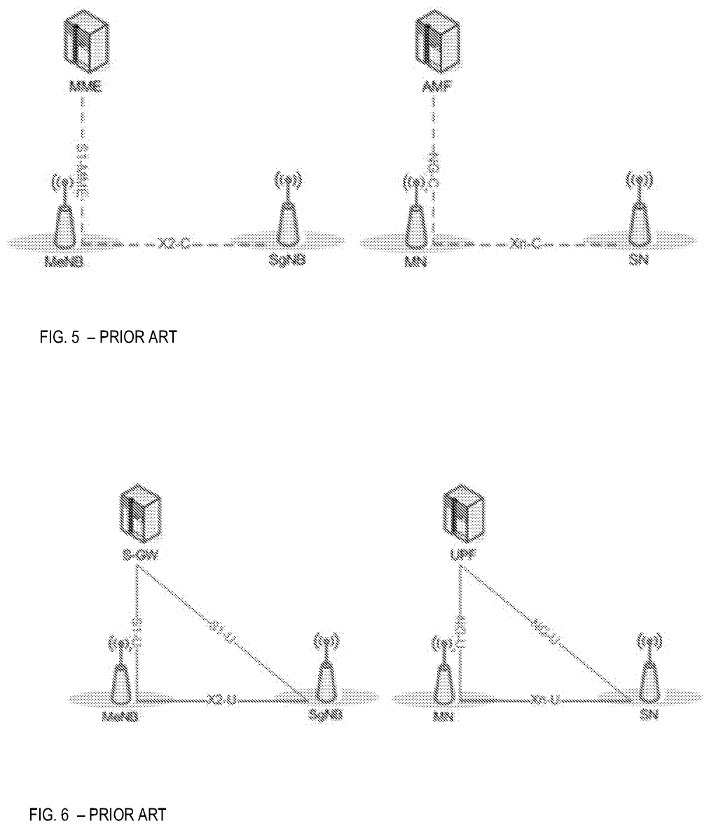

### DETAILED DESCRIPTION

According to aspects of the invention an information element denoted Radio Access Technology restriction information, RAT RI, pertaining to restrictions for a UE as to support dual connectivity over LTE access and NR access respectively for a PDN connectivity session is provided.

According to an aspect of the invention, RAT RI indicates whether a dual connectivity UE generally capable of handling LTE and NR is incapable of supporting dual connectivity for IMS services. Also during PDN connection setup procedure, the network decides the RAT restriction for this PDN. The decision can be based on subscription data, roaming agreement, local policy, etc. The MME gathers information from the UE and the network and makes the final decision of RAT restriction for this PDN. Then MME transfers the RAT RI to eNodeB for each EPS bearer belonging to the PDN.

Aspects of the invention eNodeB is assisted to make a correct steering between LTE and NR for the EPS bearers based on UE capability. Moreover, subscription data, network policy, etc may be considered. This can help avoid the potential impact on service experience, e.g. VoLTE (Voice over LTE) and ViLTE (Video over LTE), and provide a way for operators to enforce local policy and roaming agreement regarding the usage of NR or LTE.

According to an aspect of the invention it is provided that during a PDN connection setup procedure, if configured in the UE, the UE additionally includes Radio Access Technology, RAT, restriction information, RI, in the PDN Connectivity Setup Request message.

According to embodiments of the invention, two respective flags indicate a restriction for LTE and NR respectively. The RAT can only be used when it is not restricted by any node as signalled by the flags. The flags may be arranged as two flags (bits) for NR and LTE restriction respectively and signalled by the RAT RI information. If any node sets one bit, the corresponding RAT cannot be used. On the other hand, one node may omit setting any bit (e.g. set value 0) and may thus not infer any restrictions. In theory, there may be the case where no RAT can be used (in which case, the PDN setup should fail), but, it should not happen since the operator should be able to align the policy (and most likely the restriction is on NR).

According to the invention the following function tables may be used:

RAT RI (NR; LTE)

| | Received RAT | | | |
|---|---|---|---|---|
| Received RAT | RI from subscrip- | Received RAT | | Forwarded value |
| RI from UE (PDN | tion data (PDN | RI from PCRF | RAT RI (policy) in | (to ENB) (Bearer |
| level) | level) | (PDN level) | MME (PDN level) | level) |
| NR | NR | NR | NR | NR |
| 0 | 0 | 0 | 0 | 0 |
| 1 | 0 | 0 | 0 | 1 |
| 0 | 1 | 0 | 0 | 1 |
| 0 | 0 | 1 | 0 | 1 |
| 0 | 0 | 0 | 1 | 1 |
| 1 | 1 | 1 | 1 | 1 |

RAT RI (NR; LTE)

| | Received RAT | | | |
|---|---|---|---|---|
| Received RAT | RI from subscrip- | Received RAT | | Forwarded value |
| RI from UE (PDN | tion data (PDN | RI from PCRF | RAT RI (policy) in | (to eNB) (Bearer |
| level) | level) | (PDN level) | MME (PDN level) | level) |
| LTE | LTE | LTE | LTE | LTE |
| 0 | 0 | 0 | 0 | 0 |
| 1 | 0 | 0 | 0 | 1 |
| 0 | 1 | 0 | 0 | 1 |
| 0 | 0 | 1 | 0 | 1 |
| 0 | 0 | 0 | 1 | 1 |
| 1 | 1 | 1 | 1 | 1 |

| | | Exemplary E-RAB |
|---|---|---|
| | | bearer |
| RAT RI (NR; LTE) Forwarded value to eNB | | decision in eNB |
| NR | LTE | |
| 0 | 0 | No restrictions |
| 0 | 1 | Traffic scheduled only |
| | | on NR |
| 1 | 0 | Traffic scheduled |
| | | only on LTE |
| 1 | 1 | — |

Further restrictions, for instance regarding up-link and down-link, may apply for eventually setting up bearers. The bearer set-up enforcement according to the resolved RAT RI indication may according to the invention be applied to operate within—or in connection with—such further restrictions.

With regard to the options discussed in 3GPP (3/3a/3x). The outcome of this study was the definition of different radio bearer types:
MCG (Master Cell Group) bearer (uses only LTE)
MCG split bearer (uses LTE and possibly NR)
SCG (Secondary Cell Group) bearer (uses only NR)
SCG split bearer (uses NR and possibly LTE)

If there are no restrictions (NR=0; LTE=0) according to embodiments of the invention, then the RAN (eNB) decides, and based on policy, which radio bearer type to assign to which QCI bearer (e.g. QCI=5 bearer is MCG bearer, QCI=9 bearer is SCG split bearer).

If there are further restrictions, then the following is a possible way to apply the enforcement:
If NR UL (Up-Link) and DL (Down-Link) are restricted (NR=1; LTE=0), then naturally only MCG bearer can be used.
If NR UL is restricted, then SCG bearer cannot be used.
If NR DL is restricted, then SCG bearer cannot be used.

Note: there might be other reasons for the RAN to not assign a specific bearer type, e.g. due to frequency being used for NR or load.

The enforcement may be further subject to certain CQI's that apply. E.g. RAN needs to know whether NR is allowed for QCI=6/7/8/9 or whether the UE has a restriction for NR. If the UE has a restriction, then NR may be allowed only for QCI=6/7/9 but not for QCI=8. The actual values of the restricted QCI is configured on eNB.

The QoS Class Identifier (QCI) is a mechanism used in 3GPP Long Term Evolution (LTE) networks to ensure bearer traffic is allocated appropriate Quality of Service (QoS). Different bearer traffic requires different QoS and therefore different QCI values. QCI value 9 is typically used for the default bearer of a UE/PDN for non-privileged subscribers.

The QoS concept as used in LTE networks is class-based, where each bearer type is assigned one QoS Class Identifier (QCI) by the network. The QCI is a scalar that is used within the access network (namely the eNodeB) as a reference to node specific parameters that control packet forwarding treatment, for example scheduling weight, admission thresholds and linklayer protocol configuration. The QCI is also mapped to transport network layer parameters in the relevant Evolved Packet Core (EPC) core network nodes (for example, the PDN Gateway (P-GW), Mobility Management Entity (MME) and Policy and Charging Rules Function (PCRF)), by preconfigured QCI to Differentiated Services Code Point (DSCP) mapping. According to 3GPP TS 23.203 V15.0.0, (c.f. Table 6.1.7: Standardized QCI characteristics), 15 QCI values are standardized and associated with QCI characteristics in terms of packet forwarding treatment that the bearer traffic receives edge-to-edge between the UE and the P-GW. For example, QCI 5 relates to IMS.

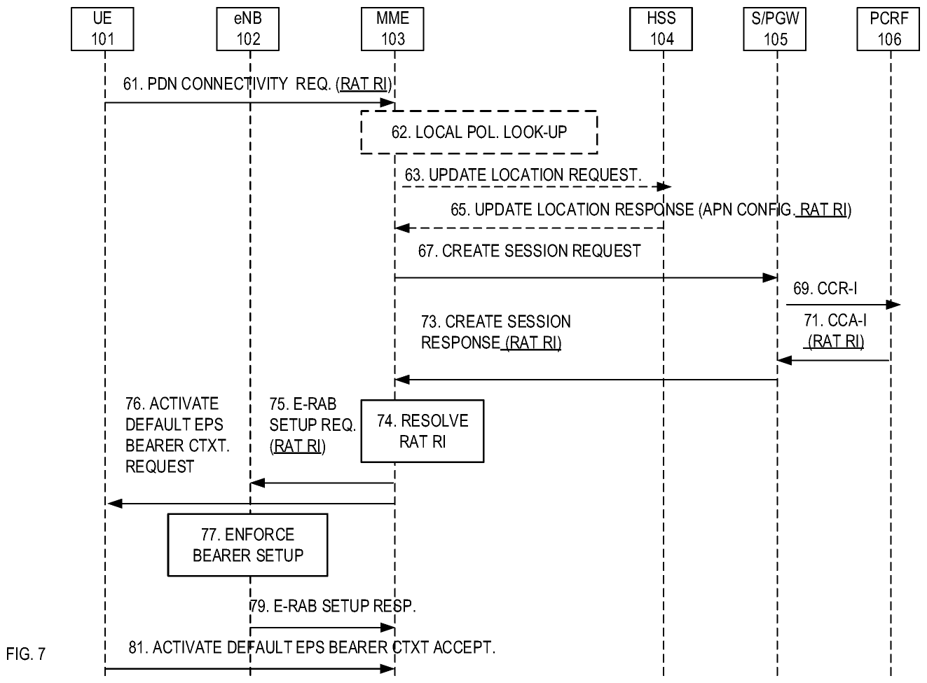

In FIG. 7 an embodiment of the invention is shown for PDN connection establishment in which a RAT restriction information, RAT RI, element is provided in various signals. The RAT RI comprises the exemplary two flags defined above.

There is shown a UE, an eNodeB, a MME, a Home Subscriber Server, HSS, a SGW/PGW (S/PGW) and a Policy and Coordination Rules Function, PCRF. In FIG. 7, the SGW and PGW is indicated as a collocated gateway entity although it is understood that these nodes could be separate entities.

As a first step—1, the UE 101 initiates the PDN connection establishment procedure by sending a PDN Connectivity Request message 61 to MME and may include an instance of a RAT RI by means of an information element as defined above. The PDN connection establishment procedure can be part of the UE initiated attach procedure.

2. The MME 103 may optionally be aware of a local policy which applies for the UE in question and performs a look-up internally 62.
3. If the PDN Connectivity Request is part of an attach procedure and the MME 103 does not have the subscription data, the MME sends an Update Location Request 63 to the HSS.
4. The HSS 104 sends an Update Location Answer 65 to the MME and includes an instance of a RAT restriction information in the APN (Access Point Name) configuration data for any APN for which that RAT restriction is provisioned.
5. The MME sends Create Session Request 67 to SGW 105 and then to PGW 105.
6. the PGW sends a CCR (Credit Control Request)-I 69 to the PCRF 106.
7. The PCRF answers with CCA (Credit Control Answer)-I 71 and includes an instance of the RAT restriction information if it is indicated by local policy.
8. The PGW sends Create Session Response 73 to the SGW and then to the MME and includes the RAT restriction information if it is received from PCRF 71.
9. The MME resolves a final RAT restriction based on subscriber data from the HSS, the indication from PGW and the local policy in MME along the lines described above. Then MME sends 75 E-RAB setup Request to eNodeB and includes the resolved RAT restriction information for the E-RAB (E-UTRAN Radio Access Bearer) corresponding to the default bearer. MME also sends an Activate Default EPS Bearer Context request to UE 76.
10. eNodeB enforces bearer set up 77 and answers 79 with an E-RAB setup response. The E-RAB setup is adapted to the properties of the UE in question such that if dual use restrictions apply for the UE in question, these restrictions are taken into consideration in the bearer set up.
11. UE responds with Activate Default EPS Bearer Context Accept 81.

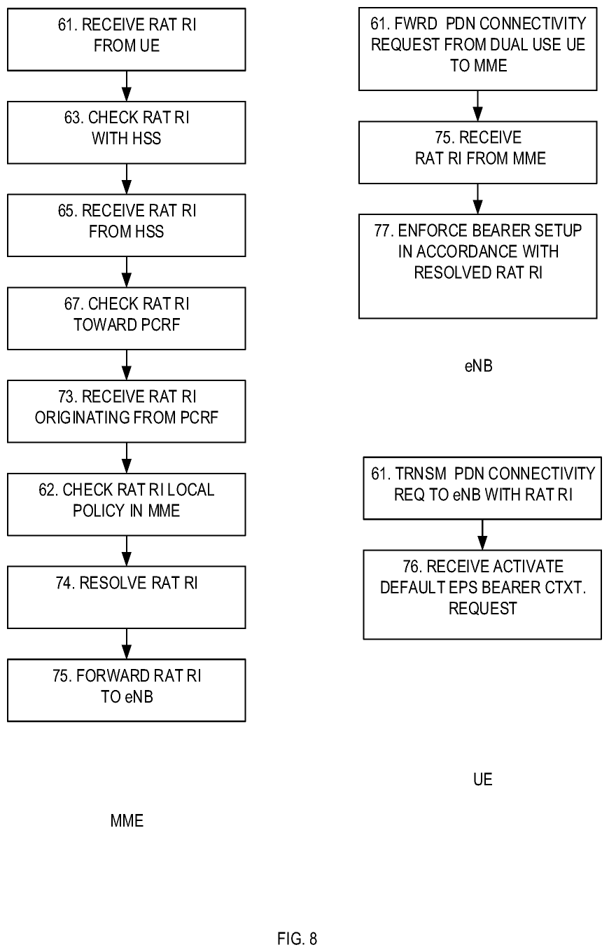

In FIG. 8, flow diagrams for MME, eNB and UE according to the embodiments of the invention are shown.

As further exemplified in the figures there is provided:

Method for a system comprising a mobility management entity, MME 103, a first Radio Access node, RAN 102, eNB offering Long Term Evolution, LTE, access, and a second radio access node, RAN 108, gNB offering New Radio, NR, access;

a user entity, UE 101, supporting both Long Term Evolution, LTE, and New Radio, NR, Radio Access Technology, RAT,
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;

### the MME 103

receiving 61 or looking-up internally 62 instances of Radio Access Technology restriction information, RAT RI, from at least two of the HSS 104, the PCRF 106 and the MME 103; the instances of RAT RI pertaining to restrictions for a UE as to support dual connectivity over LTE access and NR access respectively for a Packet Data Network, PDN, connectivity session;
resolving 74 a RAT RI from the at least two instances of RAT RI;
transmitting 75 the resolved RAT RI at least to the first RAN 102;
   the first RAN 102
receiving 75 the resolved RAT RI;
enforcing 77 bearer setup in accordance with the resolved RAT RI.

The MME may further
receive a PDN connectivity request 61 comprising an instance of a RAT RI from the UE.

According to embodiments, an instance of or resolved value of a RAT RI comprises at least two flags, a first flag indicating that a LTE restriction applies when being set and second flag indicating that a NR restriction applies when being set, the resolving 74 involving that any received instance of a RAT RI having a set flag for a respective RAT implies a set flag in the resolved RAT RI, for the corresponding respective RAT.

The enforcement involves if in the received resolved RAT RI
no flags are set-enforcing no restrictions of setting up a user plane bearer on either LTE or NR;
a LTE flag is set-enforcing a restriction of setting up a user plane bearer on LTE access and a allowing traffic to be scheduled only on NR access via the second RAN 108, gNB;
a NR flag is set-enforcing a restriction of setting up a user plane bearer on NR access and allowing traffic to be scheduled only on LTE access via the first RAN eNB—102.

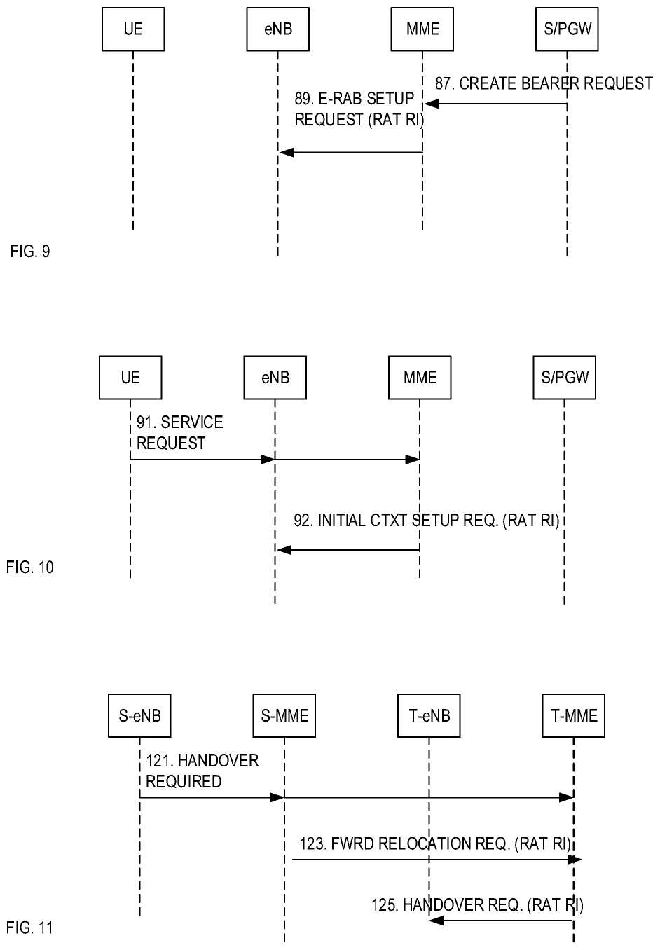

In FIGS. 9-13, additional procedures are indicated.

In FIG. 9, a Dedicated Bearer setup with RAT restriction is shown.

87. PGW sends a Create Bearer Request 87 to SGW and then to MME.

89. If RAT restriction is applicable for the PDN on which dedicated bearer is created, MME sends an E-RAB setup Request to eNodeB 89 and includes RAT restriction information for the E-RAB corresponding to the dedicated bearer.

RAT RI is on the PDN level. This procedure is for any additional dedicated bearer setup under this PDN. MME will include the RAT RI in the message sent to ENB. One PDN can have one or several bearers. One bearer means on E-RAB and one data radio bearer over air interface

In FIG. 10, a Service Request with RAT restriction procedure according to an embodiment of the invention is shown moving the UE from idle to connected. RAT RI is stored in MME. When the UE in IDLE state initiates a service request procedure to enter CONNECTED state, MME sends the RAT RI to eNB.

UE sends a service request 91 to MME.

MME sends an Initial Context Setup request 92 to eNodeB and includes RAT restriction information for any E-RAB belonging to the PDN to which RAT restriction is applicable. eNB can subsequently enforce restrictions for bearer set-up.

Hence its is provided that upon the UE transmitting a service request 91 to the MME 103, the MME 103 may be
transmitting an Initial Context Setup request 92 to the first RAN 102 comprising an instance of RAT RI for any E-RAB belonging to the PDN to which RAT RI is applicable such that the first RAN 102 can subsequently enforce restrictions for bearer set-up.

The system may moreover comprise a further mobility management entity, MME 103, denoted target MME T-MME, and a further Radio Access node, RAN 102, eNB offering Long Term Evolution, LTE, access, denoted target RAN T-eNB, the first RAN eNB; S-eNB.

FIG. 11 shows an embodiment for a S1-based handover with RAT restriction where MME sends the stored RAT RI to a target MME during inter-MME Handover. In this case, i.e. inter-MME handover, source MME sends the stored RAT RI information to target MME and then target MME sends RAT RI information to target ENB.

If MME is not changed, then MME sends the stored RAT RI to the target MME.

Source eNodeB sends a Handover Required 121 to the source MME.

Source MME sends Forward Relocation Request 123 to Target MME and includes an instance of RAT RI restriction information for each applicable PDN.

Target MME sends a Handover Request 125 to the target eNodeB and includes RAT restriction information for any E-RAB belonging to PDN to which RAT restriction is applicable.

In this procedure, the MME sends the stored RAT RI to eNB.

It is thus provided that the system may moreover comprise a further mobility management entity, MME, denoted target MME T-MME, and a further Radio Access Node, RAN eNB offering Long Term Evolution, LTE, access, denoted target RAN T-eNB,

the first RAN 102; eNB; S-eNB
transmitting a Handover Required 121 to the MME 103, S-MME;

### the MME 103, S-MME

transmitting a Forward Relocation Request 123 to the further MME T-MME comprising an instance of RAT RI for each applicable PDN;
   the further MME T-MME
transmitting a Handover Request 125 to the further RAN T-eNB comprising an instance of RAT RI for any E-RAB belonging to PDN to which RAT RI is applicable.

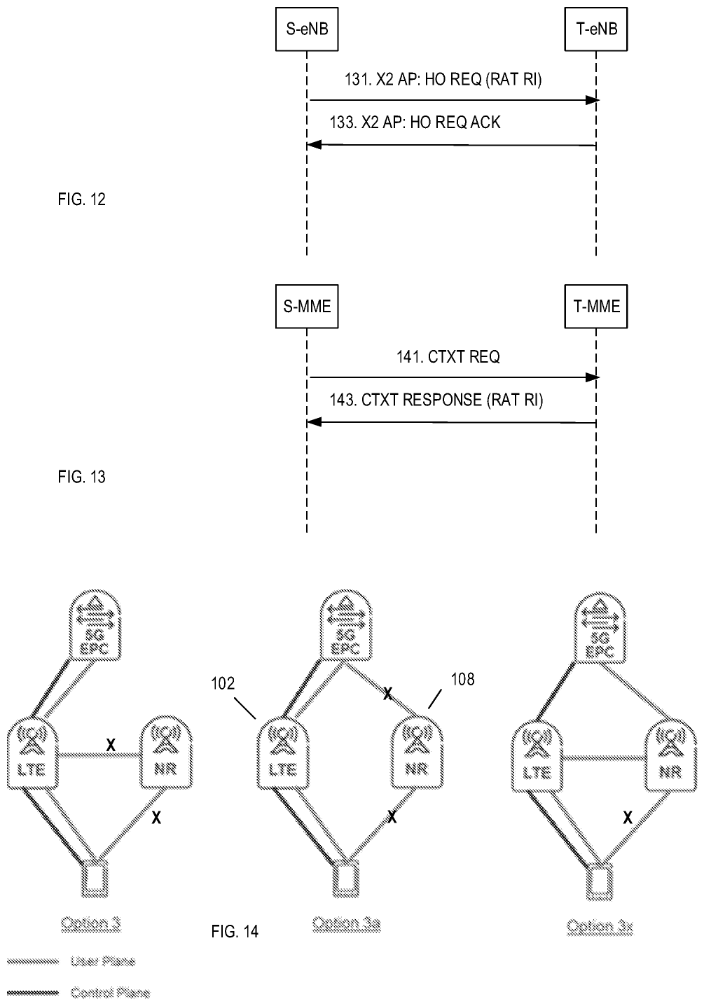

FIG. 12 shows a X2-based handover with RAT restriction. In this X2-based handover procedure, source ENB sends the RAT RI to target ENB over X2 interface.

131. Source eNodeB sends X2 AP (application protocol): Handover Request to target eNodeB and includes RAT restriction information for each applicable E-RAB.

133. Target eNodeB acknowledges the request.

Hence it is provided, that the system may moreover comprise a further mobility management entity, MME 103, denoted target MME T-MME, and a further Radio Access Node, RAN 102, eNB offering Long Term Evolution, LTE, access, denoted target RAN T-eNB, the first RAN eNB; S-eNB,

the first RAN 102, S-eNB
transmitting 131 a X2 AP Handover Request to the further RAN T-eNB RAT comprising an instance of RAT RI for each applicable radio access bearer;
   the further RAN T-eNB
acknowledging 133 the a X2 AP Handover Request to the first RAN 102, eNB.

FIG. 13 shows an embodiment for Traffic Area Update, TAU, with RAT restriction. This is another procedure and accordingly the messages, where MME send the stored RAT RI to the target MME during inter-MME idle mobility

The Target MME sends a Context Request 141 to source MME.

Source MME sends Context Response 143 to Target MME and includes RAT restriction information for each applicable PDN.

FIG. 14 is an exemplary illustration showing the enforced effects for option 3, 3a and 3x for the example where the flag for LTE restriction is set in a resolved RAT RI. In all examples bearers are not allowed between the UE and gNB on the NR interface.

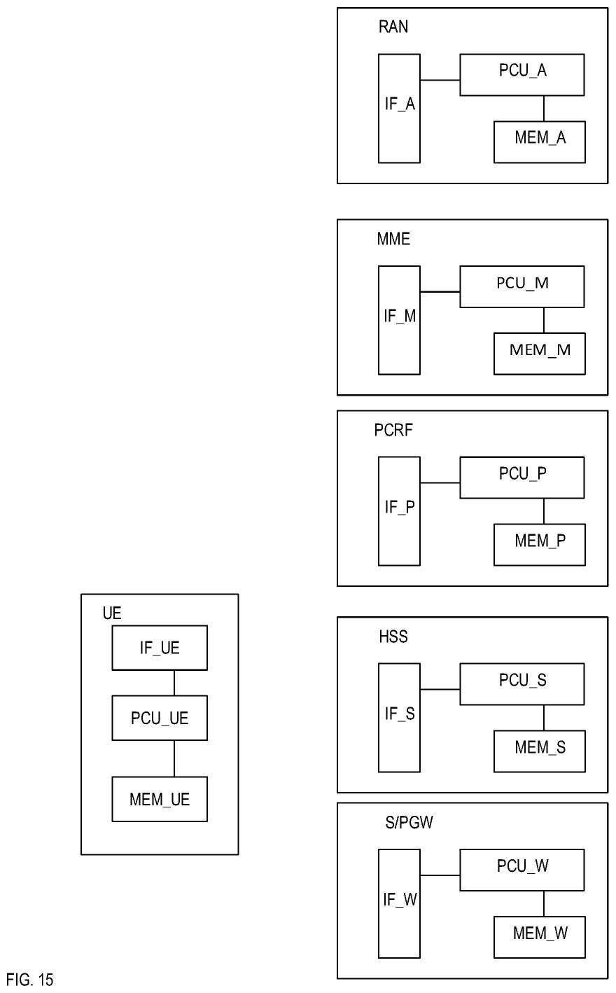

In FIG. 15, there is shown a user equipment, UE, apparatus according to an embodiment of the invention.

The UE comprises a processor PCU_UE an interface IF_UE and a memory, MEM_UE, in which memory instructions are stored for carrying out the method steps explained above. The UE communicates via the interface IF_UE. The IF_UE comprises both an external interface, communicating with a transmitter and receiver, and internal interfaces (not shown).

There is also shown a RAN comprising a processor PCU_A, an interface IF_A; and a memory, MEM_A. Instructions are stored in the memory for being performed by the processor such that the method steps explained above are carried out and signalling is communicated on the interface.

Further, a MME is provided comprising a processor PCU_M, an interface IF_M; and a memory, MEM_M. Instructions are stored in the memory for being performed by the processor such that the method steps explained above are carried out and signalling is communicated on the interface.

Moreover, a PCRF is provided comprising a processor PCU_P, an interface IF_P; and a memory, MEM_P. Instructions are stored in the memory for being performed by the processor such that the method steps explained above are carried out and signalling is communicated on the interface.

In FIG. 15, there is moreover shown a HSS comprising a processor PCU_S, an interface IF_S; and a memory, MEM_S. Instructions are stored in the memory for being performed by the processor such that the method steps explained above are carried out and signalling is communicated on the interface.

Finally, a S/PGW is provided comprising a processor PCU_W an interface IF_W; and a memory, MEM_W. Instructions are stored in the memory for being performed by the processor such that the method steps explained above are carried out and such that corresponding signalling is effectuated on the interface.

The above apparatuses/entities are adapted to communicate over known external telecom interfaces or via application programming interfaces, API, as appropriate.

It is noted that the features of the methods described above and in the following, may be implemented in software and carried out on a data processing device or other processing circuitry caused by the execution of program code means such as computer-executable instructions. Here and in the following, the term processing circuitry comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

For example, the program code means may be loaded in a memory, such as a RAM (Random Access Memory), from a storage medium, such as a read-only memory (ROM) or other nonvolatile memory, such as flash memory, or from another device via a suitable data interface, the described features may be implemented by hardwired circuitry instead of software or in combination with software.

A computer program or computer program product is provided carrying out the method steps defined above.

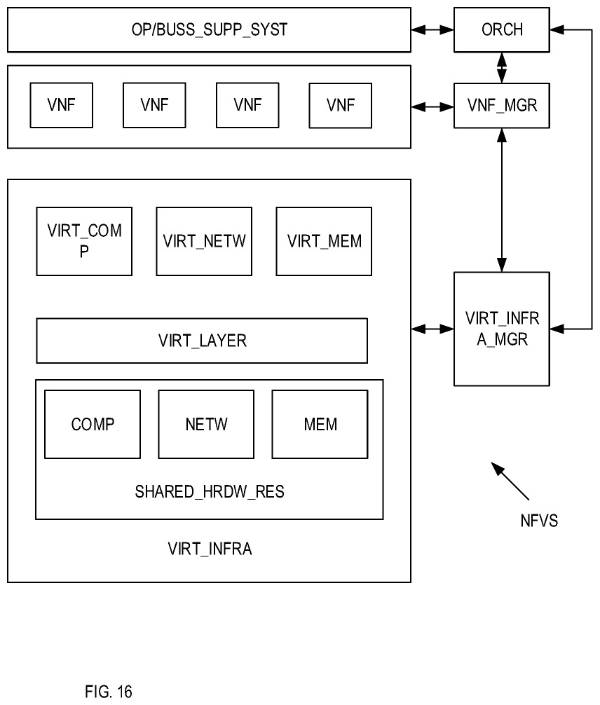

The methods discussed above may alternatively be implemented by means of a system based on network functions virtualization. In FIG. 16, further embodiments of the invention are implemented by means of such a network function virtualization system, NFVS, formed on e.g. general-purpose servers, standard storage and switches. The NFVS may be arranged along the lines described in FIG. 4, ETSI GS NFV 002 V. 1.1.1 (2013 October) and comprises the following elements: A NFV management and orchestration system comprising an Orchestrator, ORCH, a VNF manager, VNF_MGR, and a virtualised Infrastructure manager, VIRT_INFRA_MGR. The NFVS moreover comprises an operational/business support system, OP/BUSS_SUPP_SYST; a number of virtual network function instances, VNF, by which the method steps explained above are instantiated; and a virtualised infrastructure, VIRT_INFRA. The VIRT_INFRA comprises a virtual computing, VIRT_COMP, virtual network; VIRT_NETW, and virtual memory, VIRT_MEM, a virtualisation layer, VIRT_LAYER, (e.g. hypervisor) and shared hardware resources, SHARED_HARDW_RES comprising computing devices, COMP, network devices, NETW, comprising e.g. standard switches and other network devices, and standard data storage devices, MEM.

According to embodiments of the invention the following methods are disclosed, that may be implemented in the FIG. 15 or FIG. 16 realisations:

Method for a mobility management entity, MME 103, in a system comprising a first Radio Access node, RAN 102, eNB offering Long Term Evolution, LTE, access, and a second radio access node, RAN 107, gNB offering New Radio, NR, access;

a user entity, UE 101, supporting both Long Term Evolution, LTE, and New Radio, NR, Radio Access Technology, RAT,
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;

### the MME 103

receiving 61 or looking-up 62 instances of Radio Access Technology restriction information, RAT RI, pertaining to restrictions for a UE as to support dual connectivity over LTE and NR for a PDN connectivity session, from at least two of
   the HSS 104, the PCRF 106 and internally in the MME 103;
resolving 74 a RAT RI from the at least two instances of RAT RI's;
transmitting 75 the resolved RAT RI at least to the RAN 102.

Method for a first Radio Access node, RAN 102, eNB offering Long Term Evolution, LTE, access in a system comprising a mobility management entity, MME 103, and a second radio access node, RAN 107, gNB offering New Radio, NR, access;

a user entity, UE 101, supporting both Long Term Evolution, LTE, and New Radio, NR, Radio Access Technology, RAT;
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the MME moreover being adapted for signalling with a Home Subscription Server, HSS 104, a Serving Packet Data Network PDN Gateway, a PDN Gateway 105, and a Policy and Charging Rules Function, PCRF 106;

### the RAN 102;

receiving 75 a resolved RAT RI;
enforcing 77 bearer setup in accordance with the resolved RAT RI.

A method may comprise further
receiving 61 a PDN connectivity request from a dual connectivity UE comprising an instance of a RAT RI,
forwarding 61 the PDN connectivity request to the MME 103;
receiving 75 from the MME an E-RAB setup request comprising the resolved RAT RI.

The enforcement involves

if in the received resolved RAT RI
no flags are set-enforcing no restrictions of setting up a user plane bearer on either LTE or NR;
if a LTE flag is set enforcing a restriction of setting up a user plane bearer on LTE and a allowing traffic to be scheduled only on NR via the second RAN gNB;
if a NR flag is set enforcing a restriction of setting up a user plane bearer on NR and al-lowing traffic to scheduled only on LTE via the first RAN eNB.

Method for a Home Subscriber Sever, HSS 104, in in a system comprising a mobility management entity, MME 103, a first Radio Access node, RAN 102, eNB offering Long Term Evolution, LTE, access, and a second radio access node, RAN 107, gNB offering New Radio, NR, access; a user entity, UE 101, supporting both Long Term Evolution, LTE, and New Radio, NR, Radio Access Technology, RAT,

the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the method comprising the HSS
upon receiving an Update Location Request message 63 from the MME;
providing 65 an Update Location Response message comprising a RAT RI, having a value indicative of at least the UE's ability to handle RAT's to the MME.

Method for a gateway entity 105 comprising a SGW and/or PGW, in in a system comprising a mobility management entity, MME 103, a first Radio Access node, RAN 102, eNB offering Long Term Evolution, LTE, access, and a second radio access node, RAN 107, gNB offering New Radio, NR, access;

a user entity, UE 101, supporting both Long Term Evolution, LTE, and New Radio, NR, Radio Access Technology, RAT,
the MME 103 moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the gateway entity 105
receiving 67 from the MME 103 a Create Session Request 67;
transmitting 69 a CCR-I message to the PCRF;
receiving 71 from the PCRF a CCA-I message comprising an instance of RAT RI;
transmitting 73 a create session response message including the received instance 71 of the instance of the RAT RI to the MME 103.

Method for a user entity, UE, in a system comprising a mobility management entity, MME 103, a first Radio Access node, RAN 102, eNB offering Long Term Evolution, LTE, access, and a second radio access node, RAN 107, gNB offering New Radio, NR, access;

the user entity, UE 101, supporting both Long Term Evolution, LTE, and New Radio, NR, Radio Access Technology, RAT,
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the user entity being adapted for
transmitting 61 a PDN connectivity request from a dual connectivity UE comprising an instance of a RAT RI,
receiving 76 from the MME an activate default EPS bearer context request.

Also one or more programs for a computer or computer program products, comprising instructions for carrying out any of methods according to the method steps above, are provided.

According to embodiments of the invention systems and apparatuses are disclosed, that may be realized by means of the FIG. 15 examples. Alternatively, systems and apparatuses may be instantiated in a cloud computing environment as a virtual node, c.f. FIG. 16, the cloud environment comprising shared hardware resources comprising at least computing devices (COMP), memory devices (MEM) and network devices (NETW).

A system is provided comprising a mobility management entity, MME 103, a first Radio Access node, RAN 102, eNB offering Long Term Evolution, LTE, access, and a second radio access node, RAN 108, gNB offering New Radio, NR, access;

a user entity, UE 101, supporting both Long Term Evolution, LTE, and New Radio, NR, Radio Access Technology, RAT, the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the MME 103 comprising processing circuitry being adapted for
receiving 61 or looking-up internally 62 instances of Radio Access Technology restriction information, RAT RI, from at least two of the HSS 104, the PCRF 106 and the MME 103; the instances of RAT RI pertaining to restrictions for a UE as to support dual connectivity over LTE access and NR access respectively for a Packet Data Network, PDN, connectivity session;
resolving 74 a RAT RI from the at least two instances of RAT RI;
transmitting 75 the resolved RAT RI at least to the first RAN 102;
   the first RAN 102 comprising processing circuitry operative to
receiving 75 the resolved RAT RI;
enforcing 77 bearer setup in accordance with the resolved RAT RI.

A mobility management entity, MME 103, is provided in a system comprising a first Radio Access node, RAN 102, eNB offering Long Term Evolution, LTE, access, and a second radio access node, RAN 107, gNB offering New Radio, NR, access;

a user entity, UE 101, supporting both Long Term Evolution, LTE, and New Radio, NR, Radio Access Technology, RAT,
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the MME 103 comprising processing circuitry being operative to
receiving 61 or looking-up 62 instances of Radio Access Technology restriction information, RAT RI, pertaining to restrictions for a UE as to support dual connectivity over LTE and NR for a PDN connectivity session, from at least two of
   the HSS 104, the PCRF 106 and internally in the MME 103;
resolving 74 a RAT RI from the at least two instances of RAT RI's;
transmitting 75 the resolved RAT RI at least to the RAN 102.

In the Mobility management entity, MME 103, the processing circuitry can comprise a memory MEM-M, a processor PCU-M and an interface IF-M, the processor being adapted for executing instructions stored in the memory.

Radio Access node, RAN 102, eNB offering Long Term Evolution, LTE, access in a system comprising a mobility management entity, MME 103, and a second radio access node, RAN 107, gNB offering New Radio, NR, access;

a user entity, UE 101, supporting both Long Term Evolution, LTE, and New Radio, NR, Radio Access Technology, RAT;
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the MME moreover being adapted for signalling with a Home Subscription Server, HSS 104, a Serving Packet Data Network PDN Gateway, a PDN Gateway 105, and a Policy and Charging Rules Function, PCRF 106;
RAN 102 comprising processing circuitry being operative to:
receiving 75 a resolved RAT RI;
enforcing 77 bearer setup in accordance with the resolved RAT RI.

The RAN may be further being adapted to
receiving 61 a PDN connectivity request from a dual connectivity UE comprising an instance of a RAT RI,
forwarding 61 the PDN connectivity request to the MME 103;
receiving 75 from the MME an E-RAB setup request comprising the resolved RAT RI.

In the RAN, the enforcement may involve

if in the received resolved RAT RI
no flags are set-enforcing no restrictions of setting up a user plane bearer on either LTE or NR;
if a LTE flag is set enforcing a restriction of setting up a user plane bearer on LTE and a allowing traffic to be scheduled only on NR via the second RAN gNB;
if a NR flag is set enforcing a restriction of setting up a user plane bearer on NR and al-lowing traffic to scheduled only on LTE via the first RAN eNB.

The system or any node may be instantiated in a cloud computing environment as a virtual node, the cloud environment comprising shared hardware resources comprising at least computing devices COMP, memory devices MEM and network devices NETW.

A User Entity, UE 101, is provided in a system comprising a mobility management entity, MME 103, a first Radio Access node, RAN 102, eNB offering Long Term Evolution, LTE, access, and a second radio access node, RAN 107, gNB offering New Radio, NR, access;

the user entity, UE 101, supporting both Long Term Evolution, LTE, and New Radio, NR, Radio Access Technology, RAT,
the MME moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the user entity 101 comprises processing circuitry being adapted for
transmitting 61 a PDN connectivity request from a dual connectivity UE comprising an instance of a RAT RI,
receiving 76 from the MME an activate default EPS bearer context request.

The UE processing circuitry may comprise a memory MEM-U, a processor PCU-UE and an interface IF-UE, the processor being adapted for executing instructions stored in the memory.

A gateway entity 105, S/PGW is provided comprising a SGW and/or PGW, in in a system comprising a mobility management entity, MME 103, a first Radio Access node, RAN 102, eNB offering Long Term Evolution, LTE, access, and a second radio access node, RAN 107, gNB offering New Radio, NR, access;

a user entity, UE 101, supporting both Long Term Evolution, LTE, and New Radio, NR, Radio Access Technology, RAT,
the MME 103 moreover being adapted for signalling with a Home Subscription Server, HSS 104, a Serving Packet Data Network PDN Gateway, a PDN Gateway 105, and a Policy and Charging Rules Function, PCRF 106;
the system providing control plane functionality via the first RAN 102, eNB and user plane functionality via either the first RAN or the second RAN;
the gateway entity 105 comprising processing circuitry being adapted for
receiving 67 from the MME 103 a Create Session Request 67;
transmitting 69 a CCR-I message to the PCRF;
receiving 71 from the PCRF a CCA-I message comprising an instance of RAT RI;
transmitting 73 a create session response message including the received instance 71 of the instance of the RAT RI to the MME 103.

In the gateway the processing circuitry comprises a memory MEM-W, a processor PCU-W and an interface IF-W, the processor being adapted for executing instructions stored in the memory.

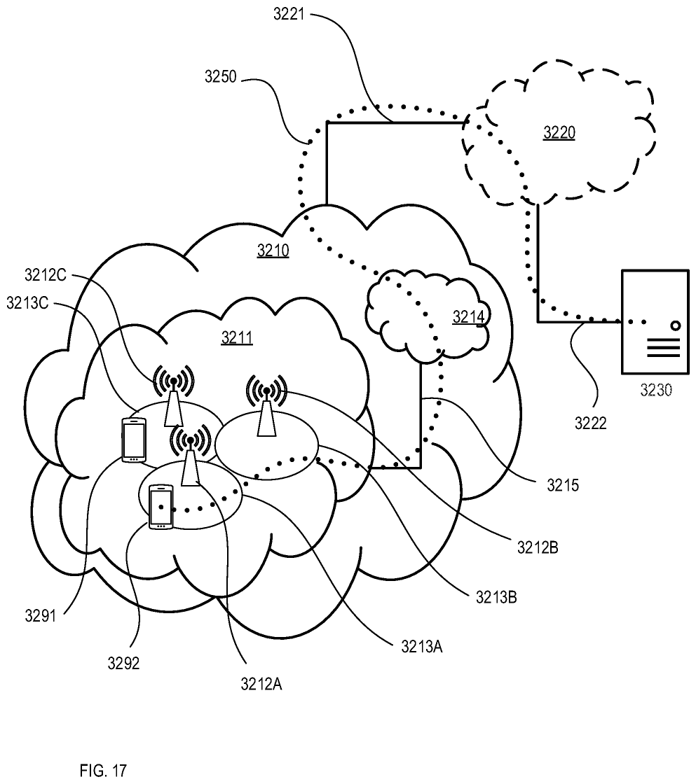

With reference to FIG. 17, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212. The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more subnetworks (not shown).

The communication system of FIG. 17 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

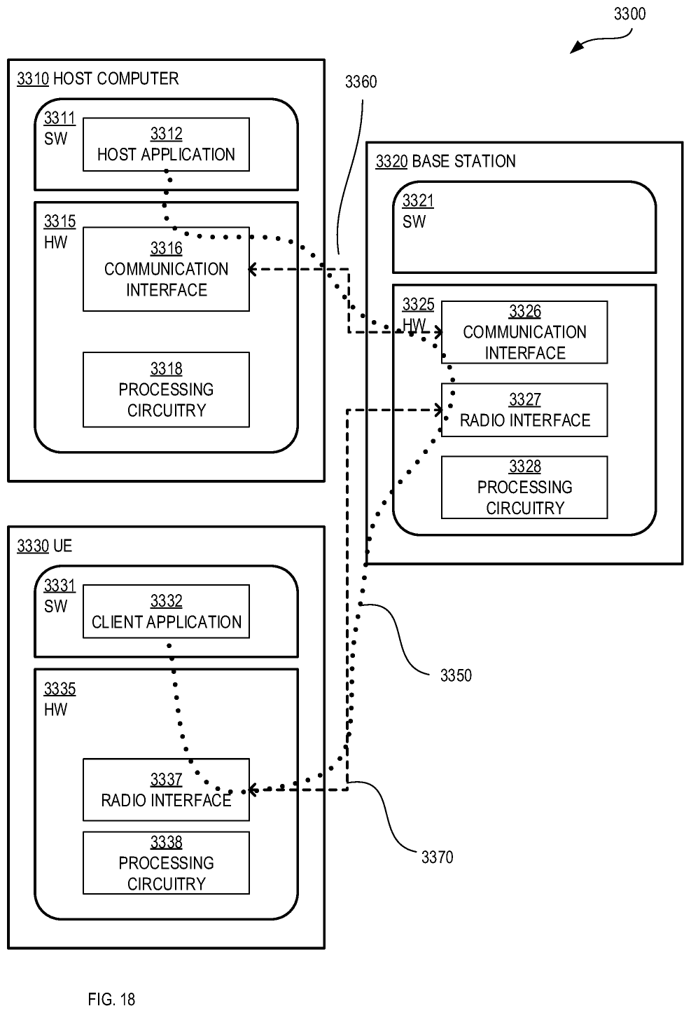

Example implementations, in accordance with an embodiment, of the UE, base station and host computer discussed in the preceding paragraphs will now be described with reference to FIG. 18. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350. The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 18) served by the base station 3320. The communication interface 3326 may be configured to facilitate a connection 3360 to the host computer 3310. The connection 3360 may be direct or it may pass through a core network (not shown in FIG. 18) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or nonhuman user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 17, respectively. This is to say, the inner workings of these entities may be as shown in FIG. 18 and independently, the surrounding network topology may be that of FIG. 17.

In FIG. 18, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., since load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the services for such dual connectivity UE's.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

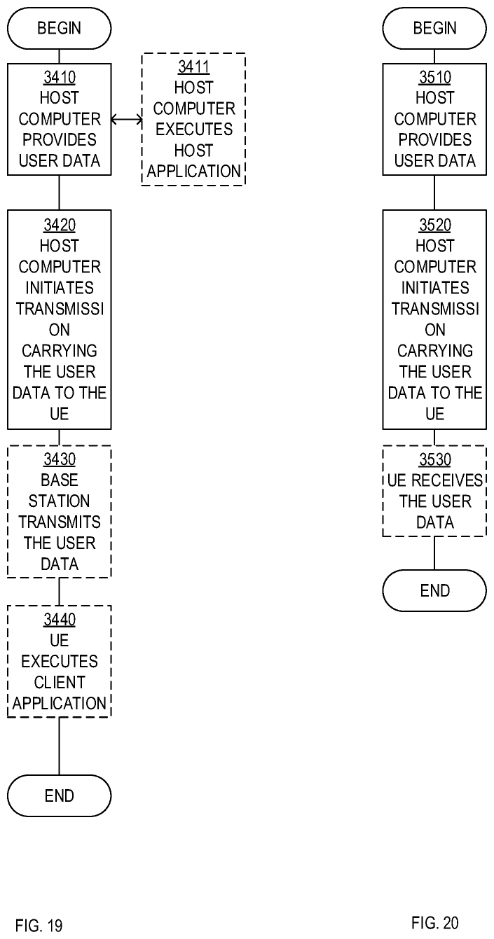

FIG. 19 is a flowchart illustrating a method implemented in a communication system, in accordance with one embodiment. The communication system includes a host computer, a base station and a UE. For simplicity of the present disclosure, only drawing references to FIG. 19 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 20 is a flowchart illustrating a method implemented in a communication system, in accordance with one embodiment. The communication system includes a host computer, a base station and a UE. For simplicity of the present disclosure, only drawing references to FIG. 20 will be included in this section. In a first step 3510 of the method, the host computer provides user data. In an optional sub-step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

### Further Numbered Embodiments

1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to—receiving (75) a resolved RAT RI; —enforcing (77) bearer setup in accordance with the resolved RAT RI.
2. The communication system of embodiment 1, further including the base station.
3. The communication system of embodiment 2, further including the UE, wherein the UE is configured to communicate with the base station.
4. The communication system of embodiment 3, wherein:
   the processing circuitry of the host computer is configured to execute a host application, thereby providing the user data; and
   the UE comprises processing circuitry configured to execute a client application associated with the host application.
5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station—receiving (75) a resolved RAT RI; —enforcing (77) bearer setup in accordance with the resolved RAT RI.
6. The method of embodiment 5, further comprising:
   at the base station, transmitting the user data.
7. The method of embodiment 6, wherein the user data is provided at the host computer by executing a host application, the method further comprising:
   at the UE, executing a client application associated with the host application.
8. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's processing circuitry configured to—transmitting (61) a PDN connectivity request from a dual connectivity UE comprising an instance of a RAT RI, —receiving (76) from the MME an activate default EPS bearer con-text request.
9. The communication system of embodiment 8, further including the UE.
10. The communication system of embodiment 9, wherein the cellular network further includes a base station configured to communicate with the UE.
11. The communication system of embodiment 8 or 9, wherein:
   the processing circuitry of the host computer is configured to execute a host application, thereby providing the user data; and
   the UE's processing circuitry is configured to execute a client application associated with the host application.
13. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE—transmitting (61) a PDN connectivity request from a dual connectivity UE comprising an instance of a RAT RI, —receiving (76) from the MME an activate default EPS bearer context request.
14. The method of embodiment 35, further comprising:
   at the UE, receiving the user data from the base station.

1-32. (canceled)

33. A Mobility Management Entity (MME) in a system comprising a first Radio Access Node (RAN) offering Long Term Evolution (LTE) access and a second RAN offering New Radio (NR) access; a user entity (UE) supporting both LTE and NR Radio Access Technology (RAT); wherein the MME is configured for signaling with a Home Subscription Server (HSS), a Serving Packet Data Network (PDN) Gateway (PDN Gateway), and a Policy and Charging Rules Function (PCRF); wherein the system is configured to provide control plane functionality via the first RAN and user plane functionality via either the first RAN or the second RAN; the MME comprising processing circuitry;
memory containing instructions executable by the processing circuitry whereby the MME is operative to:
receive or look-up instances of RAT restriction information (RAT RI) pertaining to restrictions for a UE as to support dual connectivity over LTE and NR for a PDN connectivity session, from at least two of the HSS, the PCRF, and internally in the MME;
resolving a RAT RI from the at least two instances of RAT RI's; and
transmitting the resolved RAT RI to the RAN.

34. The MME of claim 33:
wherein the RAT RI comprises at least two flags, a first flag indicating that a LTE restriction applies when being set and second flag indicating that a NR restriction applies when being set;
wherein the instructions are such that the MME is operative to perform the resolving by treating any received instance of a RAT RI having a set flag for a respective RAT as implying a set flag in the resolved RAT RI for the corresponding respective RAT.

35. The MME of claim 33, wherein the instructions are such that the MME is operative to receive a PDN connectivity request from the UE, the PDN connectivity request comprising an instance of a RAT RI.

36. A Radio Access Node (RAN) offering Long Term Evolution (LTE) access in a system; the system comprising a Mobility Management Entity (MME), a second RAN offering New Radio (NR) access, a user entity (UE) supporting both LTE and NR Radio Access Technology (RAT); wherein the MME is configured for signaling with a Home Subscription Server (HSS), a Serving Packet Data Network (PDN) Gateway (PDN Gateway), and a Policy and Charging Rules Function (PCRF); wherein the system is configured to provide control plane functionality via the first RAN and user plane functionality via either the first RAN or the second RAN; the RAN comprising:
processing circuitry;
memory containing instructions executable by the processing circuitry whereby the RAN is operative to:
receive a resolved RAT restriction information (RAT RI); and
enforce bearer setup in accordance with the resolved RAT RI.

37. The RAN of claim 36, wherein the instructions are such that the RAN is operative to:
receive a PDN connectivity request from a dual connectivity UE comprising an instance of a RAT RI;
forward the PDN connectivity request to the MME;
receiving, from the MME, an E-UTRAN Radio Access Bearer setup request comprising the resolved RAT RI.

38. The RAN of claim 36, wherein the RAT RI comprises at least two flags, a first flag indicating that a LTE restriction applies when being set and second flag indicating that a NR restriction applies when being set.

39. The RAN of claim 38, wherein the instructions are such that the MME is operative to perform the enforcing by:
in response to no flags being set in the received resolved RAT RI, enforcing no restrictions of setting up a user plane bearer on either LTE or NR;
in response to the first flag being set, enforcing a restriction of setting up a user plane bearer on LTE and a allowing traffic to be scheduled only on NR via the second RAN;
in response to the second flag being set, enforcing a restriction of setting up a user plane bearer on NR and allowing traffic to scheduled only on LTE via the first RAN.

40. A User entity (UE) in a system; the system comprising a Mobility Management Entity (MME), a first Radio Access Node (RAN) offering Long Term Evolution (LTE) access, a second RAN offering New Radio (NR) access, wherein the wherein the MME is configured for signaling with a Home Subscription Server (HSS), a Serving Packet Data Network (PDN) Gateway (PDN Gateway), and a Policy and Charging Rules Function (PCRF); wherein the system is configured to provide control plane functionality via the first RAN and user plane functionality via either the first RAN or the second RAN; wherein the UE is configured to support both LTE and NR Radio Access Technology (RAT); the UE comprising:
processing circuitry;
memory containing instructions executable by the processing circuitry whereby the UE is operative to:
transmit a PDN connectivity request comprising an instance of a RAT restriction information (RAT RI); and
receive, from the MME, an activate default Evolved Packet System (EPS) bearer context request.

41. A gateway entity functioning as a Serving Gateway (SGW) and/or a Packet Data Network Gateway (PGW) in a system; the system comprising a Mobility Management Entity (MME), a first Radio Access Node (RAN) offering Long Term Evolution (LTE) access, a second RAN offering New Radio (NR) access, a user entity (UE) supporting both LTE and NR Radio Access Technology (RAT); wherein the wherein the MME is configured for signaling with a Home Subscription Server (HSS), a Serving Packet Data Network (PDN) Gateway (PDN Gateway), and a Policy and Charging Rules Function (PCRF); wherein the system is configured to provide control plane functionality via the first RAN and user plane functionality via either the first RAN or the second RAN; the gateway entity comprising:
processing circuitry;
memory containing instructions executable by the processing circuitry whereby the gateway entity is operative to:
receive a Create Session Request from the MME;
transmit a Credit Control Request (CCR-I) message to the PCRF;
receive, from the PCRF, a Credit Control Answer (CCA-I) message comprising an instance of RAT restriction information (RAT RI); and
transmit a create session response message to the MME, the create session response message including the received instance of the RAT RI.
